(19) United States
(12) Patent Application Publication
(10) Pub. No.: US 2006/0200555 A1
(43) Pub. Date: Sep. 7, 2006

(54) System and Method for Using a Browser Plug-in to Combat Click Fraud

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/307,734

(22) Filed: Feb. 19, 2006

Related U.S. Application Data
(60) Provisional application No. 60/594,051, filed on Mar. 7, 2005.

(51) Int. Cl. G06F 15/173

(52) U.S. Cl. 709/224

(57) ABSTRACT

Search engine click fraud can be combated by a new Click Per Action method. This uses a plug-in in a browser to detect when a transaction has occurred at an advertiser's website. Here the user was directed to that advertiser by a link on a search engine's web page. Since the plug-in is independent of the advertiser, it greatly reduces the danger to the search engine that the advertiser will underreport the number and amount of transactions that were sent to it from the search engine. While the avoidance of the current Cost Per Click method reduces the click fraud suffered by current advertisers. The method can be deployed incrementally, and in conjunction with existing CPC methods.

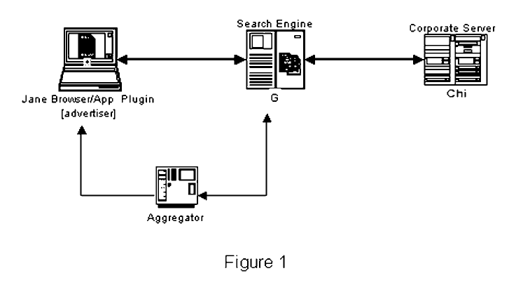

### CROSS-REFERENCES TO RELATED APPLICATIONS

This application claims the benefit of the filing date of U.S. Provisional Application, No. 60/594,051, “System and Method for Using a Browser Plug-in to Combat Click Fraud”, filed Mar. 7, 2005.

### REFERENCES CITED

google.com
yahoo.com
“Search Engine Marketing, Inc: Driving Search Traffic to Your Company's Web Site” by Moran and Hunt, Addison-Wesley 2005.
“Pay-per-Click Search Engine Marketing Handbook: Low Cost Strategies to Attracting New Customers” by Mordkovich and Mordkovich, Lulu 2005.
“Click Fraud: Judging the Scope of the Problem” by Satagopan et al, Jupiter Research 2005.

### TECHNICAL FIELD

This invention relates generally to information delivery and management in a computer network. And specifically to the use of ads in search engines, and the mechanisms by which the advertisers get charged for those ads.

### BACKGROUND OF THE INVENTION

The pervasive reach and use of search engines by users throughout the world has led to the attractiveness of advertising being placed on these engines. Typically, when a user searches for a phrase, words from that phrase might be used by the engine to determine ads that are placed in the results page. These ads are links. But instead of linking directly to the advertiser's website, a link often goes to the search engine's website. The web server on that website then redirects the user's browser to the advertiser's website. Crucially, the server increments a counter that measures the number of times a user clicked on a link to that advertiser, on one of the search engine's web page. At preset intervals, that counter's value helps determine the fee that the advertiser pays the search engine. It is for this reason that the ad link goes back to the search engine, first. This model is known as Cost Per Click (CPC).

For a search engine, such ad revenue may constitute the majority of its total revenue. But it has been observed in the search industry that as the ad revenue has increased for the various engines, so too has what is termed “click fraud”. At the simplest level, this constitutes someone who clicks on an ad link on a search results page, with no intent to buy any item (assuming that the ad is for items for sale). Clearly, a trivial next step is for that person to click repeatedly on ads for a given company, or for several companies.

Who does this? Imagine two companies, Chi and Psi, who compete selling similar products. Let Chi advertise at search engine G. Since Chi pays G some amount per click, Psi might hire people to use browsers at various locations on the Internet and go to G and Chi's ads and click on these, without actually buying anything at Chi's website, driving up Chi's cost. This is the simplest incarnation of click fraud.

As ad revenue to the search engines has risen, so too has the amount of click fraud. Numbers are inexact, but it is believed that both the absolute amount and percentage of ad revenue due to click fraud has also risen. The inexactness partly arises from search engines keeping their estimates confidential. But a more basic reason is that defining click fraud is very subjective. This adds greatly to the cost of combating it. Third party companies, independent of search engines and advertisers, have grown to offer such antifraud services. Plus, the search engines and many advertisers now incur increased costs due to maintaining internal efforts to detect these.

Antifraud techniques are mostly proprietary, but public methods include limiting the number of clicks from a given IP address in a period of time, like a day, in the counting of ad commissions. Ironically, the limitation in this method is that it might actually understate the income a search engine should receive. Imagine that a computer is heavily used, as in a cybercafe or library. Then, within that time period, different users might well go to the same search engine, and click on ads for different companies, or even, coincidentally, for the same companies.

Click fraudsters might then escalate to more sophisticated methods. All this leads to a cycle of increased effort on both sides. In general, the antifraud methods are mostly essentially probabilistic or heuristic (rules of thumb) estimates that a given behavior is done with fradulent intent.

The CPC model is fundamentally flawed. Because ultimately, a user can click on an ad with no further commitment. This is compounded by G's antifraud actions. While G may act scrupulously, the more fraud it detects, the less it gets paid by its advertisers. And much of the fraud is subjectively determined. G has an inherent conflict of interest, which may ultimately cause it to lose advertisers.

The other major alternative to CPC is often known as Cost Per Action (CPA). In this, an ad link for Chi at G's web page might go directly to Chi's website. Here, Chi is not getting billed by G per click. Instead, suppose that there is some “definitive” action at Chi's website, done by the user, which Chi values. This might include filling out information or buying something. Then, Chi pays G a commission.

There are more complex implementations of CPC and CPA, but the above descriptions are the essence of the methods.

The problem with CPA is the reverse of CPC. Now, Chi has an incentive not to report all such completed actions to G, in order to save on commissions. G might try methods such as first directly linking Chi's ad back to G, as in CPC, and thence keeping a record of such clicks. Hence, G can retain a measure of clicks going to Chi. Plus, G can have “mystery shoppers” that use various browsers to go to G and then to Chi and complete that action. Such auditing is manual and expensive. Plus, if Chi offers a range of items, it may underreport mostly on the higher priced items. Detecting this incurs even more expense due to the actual purchases needed, as compared to lower priced items.

Both CPC and CPA, as currently implemented, have weaknesses. A basic problem is how to prevent one side cheating the other.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

Search engine click fraud can be combated by a new Click Per Action method. This uses a plug-in in a browser to detect when a transaction has occurred at an advertiser's website. Here the user was directed to that advertiser by a link on a search engine's web page. Since the plug-in is independent of the advertiser, it greatly reduces the danger to the search engine that the advertiser will underreport the number and amount of transactions that were sent to it from the search engine. While the avoidance of the current Cost Per Click method reduces the click fraud suffered by current advertisers. The method can be deployed incrementally, and in conjunction with existing CPC methods.

### BRIEF DESCRIPTION OF THE DRAWINGS

There is one drawing. It shows a user at a browser with a plug-in, connected to search engine G, which then redirects it to an advertiser's website. The plug-in is also connected to the Agg, which can communicate with G.

### DETAILED DESCRIPTION OF THE PREFERRED EMBODIMENT

What we claim as new and desire to secure by letters patent is set forth in the following claims.

We described a lightweight means of detecting phishing in electronic messages, or detecting fraudulent web sites in these earlier U.S. Provisionals: Number 60522245 (“2245”), “System and Method to Detect Phishing and Verify Electronic Advertising”, filed Sep. 7, 2004; Number 60522458 (“2458”), “System and Method for Enhanced Detection of Phishing”, filed Oct. 4, 2004; Number 60552528 (“2528”), “System and Method for Finding Message Bodies in Web-Displayed Messaging”, filed Oct. 11, 2004; Number 60552640 (“2640”), “System and Method for Investigating Phishing Websites”, filed Oct. 22, 2004; Number 60552644 (“2644”), “System and Method for Detecting Phishing Messages in Sparse Data Communications”, filed Oct. 24, 2004; Number 60593114, “System and Method of Blocking Pornographic Websites and Content”, filed Dec. 12, 2004; Number 60593115, “System and Method for Attacking Malware in Electronic Messages”, filed Dec. 12, 2004; Number 60593186, “System and Method for Making a Validated Search Engine”, filed Dec. 18, 2004.

We will refer to these collectively as the “Antiphishing Provisionals”.

Below, we will also refer to the following U.S. Provisionals submitted by us, where these concern primarily antispam methods: Number 60320046 (“0046”), “System and Method for the Classification of Electronic Communications”, filed Mar. 24, 2003; Number 60481745 (“1745”), “System and Method for the Algorithmic Categorization and Grouping of Electronic Communications, filed Dec. 5, 2003; Number 60481789, “System and Method for the Algorithmic Disposition of Electronic Communications”, filed Dec. 14, 2003; Number 60481899, “Systems and Method for Advanced Statistical Categorization of Electronic Communications”, filed Jan. 15, 2004; Number 60521014 (“1014”), “Systems and Method for the Correlations of Electronic Communications”, filed Feb. 5, 2004; Number 60521174 (“1174”), “System and Method for Finding and Using Styles in Electronic Communications”, filed Mar. 3, 2004; Number 60521622 (“11622”), “System and Method for Using a Domain Cloaking to Correlate the Various Domains Related to Electronic Messages”, filed Jun. 7, 2004; Number 60521698 (“11698”), “System and Method Relating to Dynamically Constructed Addresses in Electronic Messages”, filed Jun. 20, 2004; Number 60521942 (“1942”), “System and Method to Categorize Electronic Messages by Graphical Analysis”, filed Jul. 23, 2004; Number 60522113 (“2113”), “System and Method to Detect Spammer Probe Accounts”, filed Aug. 17, 2004; Number 60522244 (“2244”), “System and Method to Rank Electronic Messages”, filed Sep. 7, 2004.

We will refer to these collectively as the “Antispam Provisionals”.

Of the CPC and CPA methods, the CPA is more promising, inasmuch as it focuses on a tangible action. For brevity, we shall assume that this action is a purchase. And that it is made by credit card. The basic problem with present practices is that anything that happens on Chi's computer is under Chi's control.

We propose a fundamental reformulation of CPA. Let Jane be a typical user. On her browser is a plug-in whose functionality we describe here. We use a plug-in because current browsers do not have this functionality. But our method also includes the case where a browser has the functionality built in. Briefly, the gist of our method is that the plug-in detects and reports the purchase, not Chi. Since the plug-in exists on the browser, it can easily be made outside the control of Chi. The details of our method are as follows.

Suppose Jane starts up her browser. The plug-in starts up, and sets an internal Boolean variable searchClick=false. The plug-in periodically connects to an Aggregation Center (Agg) that furnishes it with a list of search engine companies that are clients of the Agg and plug-in. We assume that G is on this list. The Agg was described in our Antiphishing Provisionals. In this Invention, we extend its role.

Jane goes to G's website using the browser, searches for something, and sees a G page with an ad link to Chi. The link goes to G. When Jane clicks on it, G's web server does the following. It checks if all of these are true—

1. Is there is a plug-in (with the functionality described here) at Jane's network address?

2. Does Chi use our method, and is G willing to treat it in the fashion described here?

If not, then G can redirect Jane's browser to Chi, as in the existing CPC model. In other words, our method can be retrofitted into the search engine, without requiring all or most of G's advertisers to use our method. And without requiring all or most browsers to have this plug-in.

Suppose the above checks by G were all true. Then G sends a signal to the plug-in, which sets these variables, in this optional but preferred implementation—

1. searchClick=true

2. searchEngine=G

3. advertiser=Chi

4. startTime=current time

(If G was not on the plug-in's list of search engines, then searchClick could remain unchanged, or it could be set false. And the other variables could be reset.)

More variables could be involved, in any given implementation. There might also be fewer variables. For example, the searchClick and searchEngine might be combined into one string variable, searchEngine, that is set null or blank by default, and then set above to the name (or base domain) or some other identifier of the particular search engine.

G then redirects the browser to Chi, but it does not charge Chi for this clickthrough. The plug-in programmatically monitors the pages appearing in the browser. When it detects a completed financial transaction, it tests searchClick. If this is false, then it does nothing further, as far as our method is concerned. But if searchClick=true, then it finds the URL of the current page, where the transaction ended. The plug-in reduces it to the base domain and compares it with the base domain of the advertiser variable. Here, we assume that the plug-in has a predetermined mapping from the advertiser variable to its base domain. One simple implementation would be that the advertiser variable stores the base domain.

A key issue here is how does the plug-in detect the transaction. One method involves the credit card processing processing firm used by Chi. It can expose an API or Web Service queriable by the plug-in, whereby the plug-in can obtain some anonymized data, like a hash, that is a function of the transaction.

Or, Chi can use custom tags on its completed transaction page, like <itemBought/>, for example, to designate that a transaction occurred. The syntax of these tags might be agreed upon prior to the writing of the plug-in.

In this situation, what if Chi were to periodically supress such tags, in order to avoid the plug-in counting the transaction? One answer is that the plug-in might have heuristics that scan the text pages during the transaction, to detect it, and thence to detect a successful transaction. In antispam studies, it is well known that spam messages often have random visible letters or deliberate miss-spellings, in order to evade simple content filters. But this is different from a website of a presumably reputable vendor. The pages in a website are a fixed target (even if they are dynamically generated). Having such visible randomness or mis-spellings degrades the customer experience, and may deter future sales. Plus, the plug-in can use existing antispam techniques like those in our Antispam Provisionals, to detect these. And then possibly alert the Agg or G.

Another method is that the plug-in might let Jane store her credit card numbers in it. (Naturally, when written to file, this would be done in some encrypted form.) Then, the plug-in might detect when she writes these on a webpage, and use that as information to indicate a transaction. Or, the plug-in might be actively involved in the writing of the numbers, to save Jane from having to manually type them. This might be invoked in various widgets in a webpage, possibly by a command from Jane to the plug-in. In this event, the plug-in can use this information that a transaction is occurring. We also include here the case where the browser or some other plug-in has this credit card information and can perform this writing of the information to a web page.

G can write similar programmatic tests and run these against Chi's pages. This relates to our remark above about G being willing to treat Chi in the manner of this method. G gets a wide variety of advertisers, some of which it knows very little about. It may be willing to offer the treatment of this method to, say, large advertisers, that have a well known financial history.

Returning to the plug-in and its comparison of the URLs, if they match, and if the current time is less than the startTime plus some preset maximum time interval, then the plug-in considers the transaction to have generated a commission for G.

An alternative implementation might be that the startTime not be used, and instead, the session ID of the browser when the transaction was made is compared to that of when G signalled to the plug-in. If the IDs match, then the plug-in might consider the transaction to have generated a commission for G.

If G is to get a commission, then the plug-in computes a hash. The input to the hash can include the credit card number, purchase amount, currency id and the current time of the transaction. Optionally, the input can also have a transaction ID issued by Chi or the credit card company, and a short textual description of the purchase. And possibly the buyer's name.

As above, these quantities might be extractable by the use of custom tags to isolate and identify each quantity. The use of such tags might be a precondition of the plug-in or G treating Chi's advertising in the manner of this method.

Note that these data might have to be extracted not just from the current page that indicates a successful transaction, but possibly from the previous page or pages, where, for example, the credit card numbers were entered.

The plug-in can then make a tuple, (hash, G, Chi, purchase amount), where the G, Chi and purchase amount are written as clear text. Other fields might also be present in this tuple. Though it is preferred that the credit card number and buyer's name not be present as clear text in the tuple. The advantage of using the hash is that it encodes such sensitive information as the credit card number in a one-way manner. So if a cracker were to find the above tuple, by whatever malware means, and get the hash, she cannot deduce the sensitive information that went into the hash, even knowing the clear text information in the tuple.

Who does the plug-in update?

The plug-in might send the tuple directly to G. Or to the Agg, which can then later forward it to G. (Once G has the data, it can bill Chi accordingly.) The plug-in might have logic to perform these different actions at different times. Or perhaps, a given search engine might want data sent directly to it, while another might accept it from the Agg.

The communication by the plug-in or Agg with G might be via a Web Service exposed by G for this purpose.

When does the plug-in update?

The plug-in might send the tuple as soon as it is computed, at the end of the transaction. Or, it might batch several transactions and periodically send the batch. The latter might be for optimizing network usage. Possibly in terms of the total size of bandwidth needed. Or perhaps the recipient, G or the Agg, might prefer to get the data at a time of low incoming bandwidth.

Another reason for a batch update to the Agg or G is that this might let either run verification methods on the plug-in, to ensure that it is not a fake.

Rollback

A key issue is what happens if there is a rollback. Suppose that Jane decides to undo her purchase. Or perhaps her purchase was made fradulantly by someone else with access to her credit card number.

Let T be the credit card processing firm, that Chi uses. Assume that it can also find the input string to the hash. Hence it can find the hash. If there is a rollback, Chi loses the associated revenue. It has incentive to then avoid paying the commission to G. Chi can inform T and ask it to contact G. G and T have enough information to perform a zero knowledge protocol with each other, to verify that they share common information. This is along the lines of “0046”, where we described how two parties can do this, to verify in a zero knowledge manner that each has the same information. Or, of course, G and T could use any other (presumably automated) means such that G is informed of the rollback and hence does not charge Chi a fee.

The preferred implementation is for the rollback request to G to come from T. This is more reassuring to G than from an arbitrary advertiser.

Auditing

The rollback illustrates one usage of the data that G gets. The clear text and hash that it gets for each transaction lets G maintain an auditable archive. This archive gives an anonymous query feature defined in “0046”, that protects the privacy of the users. Plus, by G not knowing the credit card numbers, it is protected against liability of being a direct party to the transaction.

Reviews

Another usage involves review websites. These publish reviews of various goods and services, including books, music, concerts, airlines, hotels, restaurants, travel cruises and plays. Though typically any given site might specialize in only one of these areas. A review is often text plus some numeric value that ranges in meaning from “poor” to “excellent”.

Often a site might solicit reviews from anyone. But in this case, a continual problem is “gaming”. This is where a restaurant, say, has someone (like an employee or friend of an employee) go to the site and post a bogus favorable review. Another type of gaming involves a rival company, that provides a competing good or service, hiring people to write bad reviews of its competitors.

In response to either of these events, a review site has various countermeasures. Like checking the electronic address from which the reviewer came from, to see if this is an address of the restaurant being reviewed, or that of a competitor. Or perhaps it is the same address of other presumably different reviewers who also gave good or bad reviews? Plus perhaps the review is read by someone at the website, prior to posting, to try and further deduce if the content is authentic.

We offer an objective test. The website can ask a reviewer to furnish a token, as part of the review submission. This token designates that the reviewer bought that good or service that she is reviewing. The token is essentially the tuple discussed earlier. When the reviewer presumably made that transaction, she got this token. Hence the website can verify the token with an Agg or a credit card processing firm. Without the reviewer having to reveal her actual credit card number to the review website. Optionally, but not preferably, the website might verify the token with the company being reviewed. But this opens a chance for the company to skew the results. It is better that the website do the previous verification.

The website can choose to publish only those reviews with verified transactions. (Though these reviews might also be subject to other tests.) Or, it might also accept reviews with unverified transactions, but perhaps designate these as such if they are posted on the site. Plus, often the reviews for a good or service are averaged in some manner that might be kept secret by the review site, in order to get an overall rating for that good or service. In this “averaging”, a higher weight could be assigned to verified reviews.

The above assumes that the transactions are monetary. But it is precisely these transactions which give incentive for gaming. And the higher the value of the typical transaction, the greater the incentive.

Of course, a reviewer who has a verified transaction might still, for whatever reason, write a review that is different from what she actually thinks of the good or service. But this is very subjective. Our method lets a website impose an objective criterion to help it filter out some or most of the false reviews.

Also, some types of goods or services might have a common usage that does not involve a transaction. Books, for example, might be read in a library. Or music might be heard on a radio. So websites that review these might not necessarily want to give too high a preferential weighting to verified reviews. But travel cruises or restaurants are rarely free to use. Hence websites reviewing these could gain by emphasising verified reviews.

In this usage, there need not be a plug-in at the user's computer when the transaction occurred, where here the user is the person who later writes a review. A search engine need not have been involved in the lead up to the transaction. (Though it could be.) So if the user's computer has no plug-in, the website doing the transaction can still return her a token. This might be by various means. Like writing it on a webpage, so that she can write it down. Or, more usefully, sent in an acknowledgement email for the transaction.

Continuing in this vein, the user need not have a computer for the transaction. Perhaps she bought the item at a store and paid with a credit (or debit) card. As part of her receipt, she gets a token. This might be written in hardcopy. Or perhaps in an acknowledgement email, if she furnishes an email address to the store. She can later present the token to the review website.

Other Usages

The plug-in and Agg described here can have other usages. They can enable other antifraud methods. Specifically, these might include the methods of our Antiphishing Provisionals.

There is a danger that a competitor of Chi might want to write a fake plug-in that tells G of (fake) transactions at Chi. But this is technically harder than most current click fraud methods. If necessary, the plug-in's authenticity can be verified via strong cryptographic methods by the Agg.

The Agg could be run independently of any search engine or advertiser. Any plug-in associated with it might also be designed independently of those parties. Because each of those parties has a vested interest in biasing the plug-in and Agg towards themselves.

While we have focused on user interactions that lead to transactions, our method can also be applied to other interactions, by simple extensions of the above techniques.

Also, we have focused on credit cards as being involved in financial transactions. Our method can also be applied when other types of financial data are used, like bank account numbers.

### CONCLUSION

We replace the current search engine CPC method, which leads to click fraud that is subjectively very hard to identify. Our method uses a browser plug-in to implement a CPA approach that does not depend on an advertiser to report the transactions to a search engine where it has placed ads.

An advertiser has to do very little to implement its role in our method. This amounts to writing a few custom tags delineating certain types of data in a successful transaction. These might even be optional, with respect to a given plug-in implementation. In any event, the tags do not affect the visual presentation of its pages, nor any internal functional change. It gains by not suffering from click fraud, or the expenses to maintain an internal effort against this, or to pay a third party to research its incoming web traffic.

What is claimed is:

1. A method of a browser plug-in being told by a search engine (“G”) when the user clicks on an ad in G's page, whereupon the plug-in records G, the advertiser (“Chi”) that was chosen, and a starting time, and where G redirects the browser to Chi and does not charge Chi for a clickthrough.

2. A method of using claim 1, where the plug-in monitors the user's actions with the browser, to detect if she makes a transaction at Chi within some interval after the starting time, and, if so, to inform an aggregation center (“Agg”).

3. A method of using claim 2, where periodically the Agg informs G of transactions, so that G can bill those advertisers.

4. A method of using claim 1, where the plug-in monitors the user's actions with the browser, to detect if she makes a transaction at Chi within some interval after the starting time, and, if so, to inform G, which can bill Chi.

5. A method of using claim 1, where instead or in addition to recording a starting time, the plug-in also records a session id.

6. A method of using claim 5, where if the plug-in detects that the user made a transaction at Chi with the same browser session id, then it informs the Agg or G.

7. A method of using claim 2 or claim 4, where detecting the transaction involves the plug-in asking the credit card company that processes Chi's transactions, where this might be done via a Web Service run by that company.

8. A method of using claim 2 or claim 4, where detecting the transaction involves the plug-in detecting custom tags in a Chi web page, that indicate a completed transaction.

9. A method of using claim 2 or claim 4, where detecting the transaction involves the browser or plug-in having the user's credit card information and the user gives a command for this data to be written to a web page, as a transaction; and thus the plug-in can detect this action.

10. A method of using claim 2 or claim 4, where the data sent by the plug-in might include a hash of one or more of the credit card number, transaction amount and timestamp, plus accompanied possibly in clear text with the name of Chi and the transaction amount (collectively, a “tuple”).

11. A method of using claim 10, where the Agg or G can use this the data from the plug-in in an auditable fashion, including for rollbacks.

12. A method of using claim 10, where a user who transacts a good or service from Chi, and pays with a credit card, gets a tuple, and where if the user goes to a review website and writes a review of the good or service, that she furnishes the tuple, which the website can verify as proof of a transaction.
